(19) United States
(12) Patent Application Publication
(10) Pub. No.: US 2018/0346813 A1
(43) Pub. Date: Dec. 6, 2018

(54) A GROUND COVER MULCH COMPRISING MINERALS AND FUNCTIONAL AGENTS

(71) Applicant: STORA ENSO OYJ, Helsinki (FI)

(72) Inventors: Kaj Backfolk, Lappeenranta (FI); Elina Skerfe, Harplinge (SE); Isto Heiskanen, Imatra (FI)

(21) Appl. No.: 15/779,131

(22) PCT Filed: Nov. 25, 2016
(86) PCT No.: PCT/IB2016/057124

§ 371 Date: May 25, 2018

(30) Foreign Application Priority Data
Nov. 27, 2015 (SE) 1551544-8

(51) Int. Cl. C09K 17/52; C09K 17/50; A01G 13/02

(52) U.S. Cl. CPC C09K 17/52; C09K 2101/00; A01G 13/0268; C09K 17/50

(57) ABSTRACT

The invention relates to a ground cover in the form of a mulch, comprising a paper substrate originating from fibre-bearing pulp, preferably emanating from lignocellulosic material, which has been web-formed or sheet-formed. Paper based mulches face problems with biodegradability and microbial attacks, mechanical strength and cost. The solution according to the invention is that the fibres have been coated with one or more minerals, e.g., calcium carbonate, and the mulch comprises one or more functional agents, e.g., a colorant. Further, the mineral coated onto or into the fibres predominantly show up when precipitated in the form of one or more metal carbonates.

### FIELD OF INVENTION

The present invention relates to a ground cover, in the form of a mulch, comprising one or more minerals and one or more functional agents. Also methods for its manufacture and use thereof are disclosed. The cover is further compostable and biodegradable.

### BACKGROUND

A common solution today is to use plastic based films when planting the seeds. This plastic film prevents weed from growing, reduces amount of needed pesticides or herbicides, enhances temperature of the soil, and controls moisture content of soil.

One of the problems with plastic is that when the farmers collect the plastic film back after harvesting the crop, pieces of said film remain in the soil and contaminate it. This is one reason why a biodegradable and sustainable solution needs to be implemented. Changes in EU legislation, which already is in place, seem also to favor biodegradable alternatives in the near future.

In JP2000-083494 a film for agriculture for protecting crop plants is disclosed. It is also mentioned in the abstract that coal ash is provided to the soil. Said ash may be fly ash.

In JP2002-238366 there is also a film for agriculture for protecting crop plants disclosed (see abstract). Metal hydroxide salts are also disclosed.

In JPH11-140261 discloses a film for agriculture for protecting crop plants wherein said films may contain with metal hydroxide.

In JP2013-176314 a mulching sheet material is disclosed where fly ash is included.

Finally, in US1846185 a mulch paper is disclosed which is treated with Cu(OH)₂.

In WO2012101329 it is also disclosed a ground-cover mulch, which includes a web-formed vegetable fibre-bearing pulp, and wood distillate. The wood distillate includes birch-wood distillate. In addition, the disclosure also relates to a method for manufacturing a ground cover mulch and the use of birch-wood distillate in ground-cover-mulch applications.

The paper based alternatives face problem with biodegradability and microbial attacks, mechanical strength and costs. There is thus a need to solve the above problems and still maintain the important physical and mechanical criteria needed for paper-based mulched such as high strength, elasticity, controlled microbial degradability and cost efficient product. Also there is a need for a ground cover, preferably in the form of a mulch that act as soil stabilizer and soil nutrient, preferably with time release effect.

To summarize the background art shows that paper and plastic mulches have been investigated and used. However, industrial use of paper or cellulose films is usually limited by costs, strengths and by too fast biodegradability.

Various components may be added to a paper or a paper surface to adjust and control its properties, but it usually adds a lot of costs. There is also as said a need to enhance the opacity and control microbial activity related to substrate degradation. The usage of a less amount of binders is also desirable especially from a cost-perspective, and that the filler(s) also will act as a soil enhancer, e.g. to help maintaining the pH value of the soil, is also desirable. There is also a need for binding certain functional compounds within the mulch from a manufacturing and an environmental perspective. There is therefore a need to solve one or more of the above problems e.g. the costs and environmental problems.

The present invention addresses the problems of degradable fiber based ground covers, e.g. mulches (such as mulches made out of paper). Due to wet conditions and high microbe contents in the soil, bio-based mulches such as paper based mulches, need to be treated in order to provide controlled rate of degradation. At the same time, the paper mulch or biofilm should be eco-friendly and have certain physical properties and be durable against water and wind. The materials in the ground covers should also preferably fulfil other properties such as the usage of renewable materials or compounds derived from such materials (such as fly ash and CO₂. Said mulch should preferably also have controllable rate of degradation and not be a burden to the farmer if left in the soil.

There is thus a need for an improved ground cover, preferably in the form of a mulch. It has now surprisingly been found, that by using minerals and functional agents, a cover can be provided with such properties that solves one or more of the problems connected with fiber based (such as cellulose based) ground covers, such as mulches.

### SUMMARY OF INVENTION

The present invention thus solves one or more of the above problems, by providing according to a first aspect a ground cover, in the form of a mulch, providing an environmentally sound solution for enabling re-using of minerals, and at the same time providing a controlled biological degradation and fertilizing effect, which comprises a paper substrate originating from fibre-bearing pulp, preferably emanating from lignocellulosic material, which has been web-formed or sheet-formed, characterized in that the fibers have been coated, which coating preferably includes nucleation and/or precipitation on the fiber(s), with one or more minerals, and that said cover comprises one or more functional agents.

Also provided according to a second aspect of the invention is a method for manufacturing a ground cover according to the first aspect of the present invention, comprising the following steps:
a) providing a fiber suspension preferably a fibre-bearing pulp, most preferred emanating from lignocellulosic material,
b) providing one or more minerals,
c) coating the mineral(s) onto and/or into said fibres, predominantly showing up when precipitated in the form of one or more metal carbonate(s), preferably by using water and/or gaseous CO₂ and/or sodium carbonate, or mixtures thereof,
d) optionally adding one or more filler(s), to the fibres with precipitated mineral(s),
e) forming a paper/board web substrate, thus providing a web substrate, optionally followed by a drying step,
f) adding one or more functional agent(s) to the web substrate, and
g) optionally providing one or more additional layers, thus providing a cover. The paper web substrate may also be a multi-ply paper. The CO₂ is preferably collected from flue gases of a mill. The metal carbonates include, but is not limited to, calcium carbonate(s). In other words you can say that in step b) minerals, that may be metal hydroxides or mixtures thereof, are added whereupon in step c) they are reacted, preferably with carbonate whereas at the same time fillers may be present.

Also provided according to a third aspect of the invention is a ground cover in the form of a mulch, obtainable by a method according to the second aspect.

Also provided according to a fourth aspect of the invention is use of a ground cover in the form of a mulch, according to the first aspect in cultivation. This embraces also the use in farming and horticulture.

### DETAILED DESCRIPTION OF THE INVENTION

It is intended throughout the present description that the expression “coated” embraces in the context of fibres, useful in the context of ground covers (such as mulches), that said fibres may not be fully coated but also partly coated. It also in this context embraces lumen loaded, i.e. that the fibres may be lumen loaded.

The expressions “fibre” and “fiber” are further used interchangeably in the present description meaning the same thing.

The pulp mentioned in the present description, may be chemical pulp, mechanical pulp, thermomechanical pulp or chemi(thermo)mechanical pulp (CMP or CTMP). Said chemical pulp is preferably a sulphite pulp or a Kraft pulp.

The pulp may consist of pulp from hardwood, softwood or both types. The pulp may e.g. contain a mixture of pine and spruce or a mixture of birch and spruce. The chemical pulps that may be used in the present invention include all types of chemical wood-based pulps, such as bleached, half-bleached and unbleached sulphite, Kraft and soda pulps, and mixtures of these. The pulp may be of dissolving pulp type. The pulp may also comprise textile fibers, polymers or synthetic fibres. The pulp may also come from agriculture (e.g. potato, bamboo, wheat, bagasse or carrot). The pulp may also be nanocellulose, microfibrillated cellulose or cellulose whiskers. Said nanocellulose, microfibrillated cellulose or cellulose whiskers may also be chemically modified. Also combinations of said pulp types are possible in the context of the present invention. The pulp may also contain synthetic fibers or biofibers such as PLA (Poly-lactic acid). The pulp may also emanate from broke, recycled pulp, and sludge.

The minerals mentioned in the present description may be one or more minerals, such as carbonized minerals emanating from one or more metal hydroxides, for example calcium hydroxide, magnesium hydroxide and/or fly ash, preferably wherein said mineral(s) has/have been recycled and thus said minerals are re-used.

It is intended throughout the present description that the expression “minerals” also embraces in the context of ground covers (such as mulches), non-carbonized metal hydroxides, such as calcium hydroxide, magnesium hydroxide. In the context of the present invention also fly ash is included in the expression mineral(s) even though this normally comprises different mineralogical compounds.

Said minerals may also be present in the form of particles (fines), which may comprise one or several metal hydroxides. Said minerals may also be calcined. This provides a low brightness material. Said fly ash could be derived from bottom ash, textile filters, electrostatic precipitators. Said ash may also be of different types e.g. it may be derived from biomasses, or coal.

There are also different mineralogical phases in fly ash from the paper industry which are e.g. quartz, calcite, lime, calcium silicate, anhydrite, merwenite, magnesite and gehlenite. The major chemical elements are CaO, SiO₂ and Al₂O₃ (in order high to low). The size distribution of the fly ash varies between type of boiler, incineration conditions etc. A typical paper mill ash has all particles <500 μm. 50% <30 μm. Other possible fly ashes could also be, in the context of the present invention, coal fly ash and wood fly ash (on condition that the CaO content is high enough). Fly ash from waste incineration is also possible, but may be polluted and therefore might need extra treatment. Fly ash from different steps in the flue gas treatment could also be used in this context. Different kinds of treatment methods to improve the properties may also be used such as fractionation and/or grinding. The fly ash may also be purified.

Said coating procedure in step c) (which may involve nucleation, precipitation and/or crystallization on the fiber) may further be made according to an in-line technique alternatively to an at-site or off-line method.

Said coating procedure can also be made on part of the fiber fraction (which may be done before said fraction is added to the rest of the fibres which in turn is treated) and also at different fiber concentrations. The coating procedure can also take place in presence of other functional agents (such as performance chemicals).

It is intended throughout the present description that the expression “thermoplastic” embraces any thermoplastic polymer (which may be of fossil origin) that may be useful in the context of the manufacturing of ground covers, such as mulches. Said polymer may be, but is not limited to acrylates such as PMMA, PP (Polypropylene), PE (Polyethylene) such as HDPE (high density PE), MDPE (medium density PE), LDPE (low density PE), PA (Polyamide) such as nylon, PS (Polystyrene), Polyvinylchloride (PVC), polysulfone, ether ketone or polytetrafluoroethylene (PTFE). The PE may further be cross-linked (PEX). It may further be co-polymers comprising two or more of said polymers or mixtures comprising two or more of said polymers. Preferably PP (Polypropylene) or PE (Polyethylene) is used.

According to a further preferred embodiment of the first aspect of the invention the ground cover contains additionally one or more fillers.

According to a further preferred embodiment of the first aspect of the invention the filler is selected from the group comprising talc, kaolin, lime, silica and aluminum oxides or combinations thereof.

According to a further preferred embodiment of the first aspect of the invention the functional agent(s) is (are) one or more colorant(s) and/or one or more performance chemical. Said functional agents may improve the opacity and reduced brightness. Said substrate of the first aspect may also be surface sized, impregnated or surface treated to provide features such as controlled mechanical properties, biodegradability and/or hydrophobicity.

According to a further preferred embodiment of the first aspect of the invention the performance chemical(s) is (are) selected from the group: strength additives, hydrophobic agents and retention chemicals or combinations thereof. Said performance chemical(s) may also be one or more of the following:

Wet strength chemicals which can be e.g. UF resins (urea-formaldehyde), melamine-formaldehyde resins (MF), polyamide-amine epichlorohydrine (PARE), Epichlorohydrine (ECH), polyacryl amide/glyoxal, starch/glyoxal

Water soluble polymers such as fixing agents (PDADMAC, CPAM, PEI, PVAm, cationic starch), retention chemicals (Cationic

PAM, PAM, Anionic PAM, PEI, cationic starch, amphoteric starch, PEO, etc.), dry (cationic starch, different gums, acrylamide based polymers (PAM), polyvinyl amine (PVAm), CMC, chitosan, etc.) and wet strength agents (see above). Sizing dispersions such as alkyl ketene dimer (AKD), alkenyl succinic anhydride (ASA), rosins.

Pigments CaCO3, etc. and organic pigments such as starch pigments.

Surface sizing or coating chemicals that includes
latexes such as styrene/butadiene, styrene/acrylate, or SMA, SMI, PE emulsions, nanostarch
cross-linkers
chemicals to control electrical or dielectric properties such as electrolytes
binders to control surface strength and e.g. dusting

According to a further preferred embodiment of the first aspect of the invention the colorant(s) include one or more UV absorbents and/or a carbon black.

According to a further preferred embodiment of the first aspect of the invention said ground cover comprises also one or more biocide(s) and/or nutrient(s). The biocides may be a fungicide or a bactericide or a combination thereof. The nutrient may also be a stimulant for photosynthesis.

According to a further preferred embodiment of the first aspect of the invention the carbon black emanates from a non-fossil source, preferably from biomass or organic waste residues of non-fossil origin. The source is preferably lignin.

According to a further preferred embodiment of the first aspect of the invention said cover comprises also one or more additional layers. Said layers may be formed by nanocellulose, microfibrillated cellulose and/or cellulose whiskers, or by a thermoplastic, or by a composite comprising both fibres of lignocellulosic origin and one or more thermoplastics. Said nanocellulose, microfibrillated cellulose or cellulose whiskers may preferably be added in an amount of 0.2-40 g/m² or more preferably in an amount of 1-30 g/m² or most preferably in an amount of 5-25 g/m². Said nanocellulose, microfibrillated cellulose or cellulose whiskers may be added in the form of a suspension that may additionally comprise other process or performance chemicals suitable in said context. The additional layer may provide enhanced characteristics related to enhanced water barrier, fumigation, oxygen barrier etc. but it may also have an influence on strength properties and also dimensional stability which is of importance.

According to a further preferred embodiment of the method according to the second aspect of the present invention the forming is made with a dry or wet laid process, preferably a wet laid process.

According to a further preferred embodiment of the method according to the second aspect of the present invention steps c) and d) is performed at the wet end of a paper/board production line. The paper may, as said earlier, be a multi-ply paper.

According to a further preferred embodiment of the method according to the second aspect of the present invention step f) also comprises adding one or more biocide(s) and/or nutrient(s).

As said the present invention provides the use of a mineral coated fiber as a material when preparing a cost efficient ground cover, preferably in the form of a paper mulch. Further the synthetized mineral(s) may preferably be precipitated onto the fibers by using e.g. CO₂. By this fixing approach, it is possible to reduce costs of the substrate, enhance the opacity and enhance the biocidic effect (control degradation). The approach requires also less binder and it will also act as a nutrient for the soil. In addition the present invention solves the problem with binding of fly ash from an environmental perspective. Thus the present invention also allows the re-use and spreading of fly ash (being part of a ground cover) in an efficient way, which is an ecologically sound solution.

The composition of the raw material (preferably involving fly ash) should preferably have high content of CaO (>30%), whereas the brightness is less significant. In fact, a lower brightness grade is more preferred in order to prevent light transmission. A dark pigment will enable less need for black pigment (filler) in the surface treatment step. By utilizing this approach, it is possible to control the dosing of functional agents and minerals to soil.

There may also be an amount of Fe, Mg, Na, K, Zn and so on in fly ash and they may more act like tracers.

The usage of fly ash (instead of lime) can also reduce CO₂ emissions. In addition one can expect that fly ash in itself has also pesticide effects for the ground cover, in the form of a mulch. Also as fly ash is bound in the ground cover according to the first aspect of the present invention, less fly ash will be washed with waters to ground water (compared to normal addition methods of fly ash). The ground cover according to the first aspect of the invention, such as a mulch, may also be helpful (e.g. in greenhouse environments) for improving heat retention in winter and cooling in summer to extend the growing season. The ground cover may also be helpful for soil conditioning/soil amendment to improve poor soils, or to rebuild soils. Said ground cover may also be helpful for enhancing soil stewardship mechanism for locking carbon into soil. Said ground cover may also contribute in such a way that a lower amount of chemical fertilizers may be needed. Also precipitation might occur in the presence of additional fertilizing chemicals such as e.g. phosphates, urea, etc. that also could enhance said effect of the ground cover.

Preferred features of each aspect of the invention are as for each of the other aspects mutatis mutandis. The prior art documents mentioned herein are incorporated to the fullest extent permitted by law.

In view of the above detailed description of the present invention, other modifications and variations will become apparent to those skilled in the art. However, it should be apparent that such other modifications and variations may be effected without departing from the spirit and scope of the invention.

1. A ground cover in the form of a mulch, providing an environmentally sound solution for enabling re-using of minerals and at the same time providing a controlled biological degradation and fertilizing effect, which comprises a paper substrate originating from fibre-bearing pulp, which has been web-formed or sheet-formed, wherein the fibers have been coated with one or more minerals, and the mulch comprises one or more functional agents.

2. A cover according to claim 1 wherein the minerals are one or more carbonized minerals.

3. A cover according to claim 1 containing additionally one or more fillers.

4. A cover according to claim 3, wherein the filler is selected from the group consisting of talc, kaolin, lime, silica and aluminum oxides or combinations thereof.

5. A cover according to claim 1 wherein the functional agents are one or more colorant(s)colorants and/or one or more performance chemicals.

6. A cover according to claim 5 wherein the performance chemicals are selected from the group: strength additives, hydrophobic agents and retention chemicals or combinations thereof.

7. A cover according to claim 5 wherein the colorants include one or more UV absorbents and/or a carbon black.

8. A cover according to claim 1 further comprising one or more biocides and/or one or more nutrients.

9. A cover according to claim 7 wherein the carbon black emanates from a non-fossil source.

10. A cover according to claim 1 further comprising one or more additional layers.

11. Method for manufacturing a ground cover according to claim 1 comprising the following steps:
a) providing a fiber suspension,
b) providing one or more minerals,
c) coating the minerals onto or into said fibres,
d) forming a paper/board web substrate, thus providing a web substrate or sheet, and
e) adding one or more functional agent(s) to the web substrate, thus providing a cover.

12. Method for manufacturing a cover according to claim 11 wherein the forming is made with a dry or wet laid process.

13. Method for manufacturing a cover according to claim 11 wherein step c) is performed at the wet end of a paper/board production line.

14. Method for manufacturing a cover according to claim 11 wherein step e) also comprises adding one or more biocide(s) and/or nutrient(s).

15. A ground cover in the form of a mulch, obtainable by the method of claim 11.

16. (canceled)

17. A cover according to claim 1, wherein the fibre-bearing pulp emanates from lignocellulosic material.

18. The cover according to claim 2, wherein the one or more carbonized minerals emanates from one or more metal hydroxides.

19. The cover according to claim 2 wherein the one or more carbonized minerals have been recycled.

20. A cover according to claim 9 wherein the non-fossil source is from biomass or organic waste residues of non-fossil origin.

21. The method according to claim 11, wherein the minerals are precipitated in the form of one or more metal carbonates.

22. The method of claim 21, wherein metal carbonates include calcium carbonate that is precipitated by using water and/or gaseous CO₂ and/or sodium carbonate, or mixtures thereof.

23. The method according to claim 11 further comprising adding at least one filler, to the fibres with precipitated minerals after step c).

24. The method according to claim 11 further comprising a drying step after step d).

25. The method according to claim 11 further comprising providing one or more additional layers to the web substrate.
